(19) United States
(12) Patent Application Publication
(10) Pub. No.: US 2024/0360001 A1
(43) Pub. Date: Oct. 31, 2024

(54) PROCESSES AND SYSTEMS FOR PRODUCING A NICKEL SULFATE PRODUCT

(71) Applicant: BASF SE, Ludwigshafen am Rhein (DE)

(72) Inventors: Stefan Pichlmair, Iselin, NJ (US); Ralf Boehling, Ludwigshafen (DE); Sabine Frischhut, Ludwigshafen (DE); Vincent Smith, Midrand (ZA)

(73) Assignee: BASF SE, Ludwigshafen am Rhein (DE)

(21) Appl. No.: 18/291,277

(22) PCT Filed: Jul. 28, 2022
(86) PCT No.: PCT/EP2022/071290

§ 371 Date: Jan. 23, 2024

(30) Foreign Application Priority Data
Jul. 30, 2021 (EP) 21188970.4

(51) Int. Cl. C01G 53/10

(52) U.S. Cl. CPC C01G 53/10

(57) ABSTRACT

The present disclosure is directed to processes and systems for dissolving elemental nickel in sulfuric acid solutions to produce nickel sulfate products, and for example. nickel sulfate products suitable for battery materials production.

This application claims the benefit of European Patent Application No. 21188970.4, filed on 30 Jul. 2021, the contents of which is incorporated by reference herein in its entirety.

Nickel sulfate is useful for a number of applications such as, for example, as a source of electrode material for nickel-hydrogen and lithium-ion batteries. These types of batteries find use in hybrid electric cars, mobile phones, personal computers, and the like. They are therefore increasingly in demand, especially over the past decade and this need continues to grow at a high rate.

One method of producing nickel sulfate is by dissolving elemental nickel in sulfuric acid. This process requires a secure environment as volatile hydrogen gas is produced during the process, creating a hazardous environment. Additionally, the process of dissolving elemental nickel in aqueous solutions of acids is often impractically slow in most non-oxidizing acids and even in some oxidizing acids under certain conditions.

U.S. Pat. No. 6,554,915, for example, describes a process of dissolving metallic nickel in a non-oxidizing aqueous acidic solution that requires the use of an additional oxidizing agent unless the nickel used is in the form of fine powder. However, the presence of oxidizing agents, such as ozone or hydrogen peroxide, in the final nickel salt solution may preclude its use in certain applications and necessitate additional post workup procedures to purify the product. These additional procedures add to the cost and decrease the efficiency of the process.

Another consideration in producing nickel sulfate is that the nickel sulfate to be used as a raw material in battery production should have a relatively high pH, for example, about 4. However, the reaction rate of elemental nickel with sulfuric acid requires a sufficiently low pH (about 0.5 to about 2) when reacting under the exclusion of oxidizing agents.

Accordingly, there is a need for alternative processes and systems to produce nickel sulfate products in a cost effective and safe manner, such as nickel sulphate products that are suitable for use as raw materials for battery production.

The present disclosure is directed to processes and systems for dissolving elemental nickel in sulfuric acid solutions to produce nickel sulfate products, and for example, nickel sulfate products suitable for battery materials production. In the present disclosure, it was surprisingly found that a two-step setup with two vessels has the advantage that a pH gradient can be created to produce a nickel sulfate product with a comparatively high pH of, for example, between about 2 and about 4. In the present disclosure, it was also surprisingly found that clean hydrogen gas is produced as an off-gas, which can, for example, be further used in the processes and systems to generate heat or can be used for other processes.

The present disclosure provides for a process for preparing a nickel sulfate product. The process can include introducing elemental nickel, sulfuric acid, and water into a primary vessel to form a primary nickel sulfate solution. The primary nickel sulfate solution can be transferred from the primary vessel to a secondary vessel and additional elemental nickel may be added. The secondary vessel can collect any unreacted nickel from the primary vessel and allow the primary nickel sulfate solution to further react with the unreacted nickel to form a secondary nickel sulfate solution.

The process can include collection of a high purity hydrogen off-gas flow from the primary vessel and/or the secondary vessel. The high purity hydrogen off-gas flow can heat water to produce steam for controlling the temperature of the process in the primary vessel and/or the secondary vessel. The process may be free of oxygen, air, and hydrogen peroxide. The process may be carried out at a temperature ranging from about 40° C. to about 200° C. The process may use elemental nickel, which may be in a form chosen from pellets, rounds, cathodes, briquettes, powder, and combinations thereof.

The process may further include continuously circulating the primary nickel sulfate solution and the secondary nickel sulfate solution in each vessel. The process may be carried out using a dispersion device to minimize foam formation in the primary and/or secondary vessels. The dispersion device may be chosen from sprinklers, steamers, centrifuges, and combinations thereof.

The process of the present disclosure may be carried out at a pressure above ambient pressure and under an inert atmosphere. The inert atmosphere may be chosen from hydrogen, water vapor, nitrogen, argon, and combinations thereof. The process may also be carried out at ambient pressure.

The primary nickel sulfate solution may have an Ni²⁺ concentration ranging from about 70 g/l to about 200 g/l and a pH ranging from about 0.5 to about 2. The nickel sulfate product may have a pH ranging from about 2 to about 4. The secondary nickel sulfate solution may be filtered to produce the nickel sulfate product which may be suitable for use without further purification.

The present disclosure also provides for a system for preparing a nickel sulfate product. The system may include a primary vessel, a secondary vessel, an off-gas flow line, and a filter.

The primary vessel may include a settler for mixing elemental nickel, sulfuric acid, and water to form a primary nickel sulfate solution.

The secondary vessel may also include a settler to collect unreacted nickel particles and the primary nickel sulfate solution for further mixing with additional elemental nickel to form a secondary nickel sulfate solution.

The primary vessel and/or the secondary vessel may further comprise one or more circulation devices for circulating the primary and/or secondary nickel sulfate solution. The circulation device may be chosen from a separator, one or more pumps, and combinations thereof. The primary and/or secondary vessels may further comprise a dispersion device for minimizing foam formation therein. The dispersion device may be chosen from sprinklers, steamers, centrifuges, and combinations thereof.

The off-gas flow line may be used to collect high purity hydrogen off-gas from the primary vessel and/or the secondary vessel. The off-gas flow line may be connected from a head of the primary vessel and/or a head of the secondary vessel to a burner, to heat water for producing steam. A tube may be included to carry the produced steam into the bottom of a primary vessel and/or a bottom of the secondary vessel to control the temperature in the primary vessel and/or the secondary vessel.

The filter may be used for filtering the secondary nickel sulfate solution to collect the nickel sulfate product.

### BRIEF DESCRIPTION OF THE FIGURES

FIG. 1 is a diagrammatic representation of a comparative example of a one-column configuration for the production of a nickel sulfate product.

FIG. 2 is diagrammatic representation of a prophetic example of a two column configuration for the production of a nickel sulfate product according to one embodiment of the present disclosure.

As used herein, “a” or “an” entity refers to one or more of that entity, e.g., “a vessel” refers to one or more vessels or at least one vessel unless stated otherwise. As such, the terms “a” (or “an”), “one or more,” and “at least one” are used interchangeably herein.

As used herein, the term “about” means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. A value modified by the term “about” also includes the specific value. For instance, “about 5.0” includes 5.0.

As used herein, the term “ambient pressure” means the pressure of the surrounding air and external environment where the system and/or process of the present disclosure is being carried out. The ambient pressure is typically atmospheric pressure.

As used herein, the term “inert atmosphere” means a gaseous environment that is non-reactive in the systems and processes of the present disclosure. For example, inert atmospheres are substantially oxygen free environments that primarily consist of non-reactive gases. Exemplary non-reactive gases include, for example, nitrogen and argon.

As used herein, the term “vessel” means a structure defining a volume that is suitable for containing one or more process components, including gases, liquids, solids, and mixtures thereof. Vessels of the present disclosure may be constructed of any suitable material, with non-limiting examples of such materials including glass, elemental metals, metal alloys, plastic, laminate, ceramics or any combination thereof. The vessels may be open to the environment or closed to operate under pressure. Vessels described herein are further configured to include one or more inlets and outlets for receiving and/or releasing components of the processes of the present disclosure.

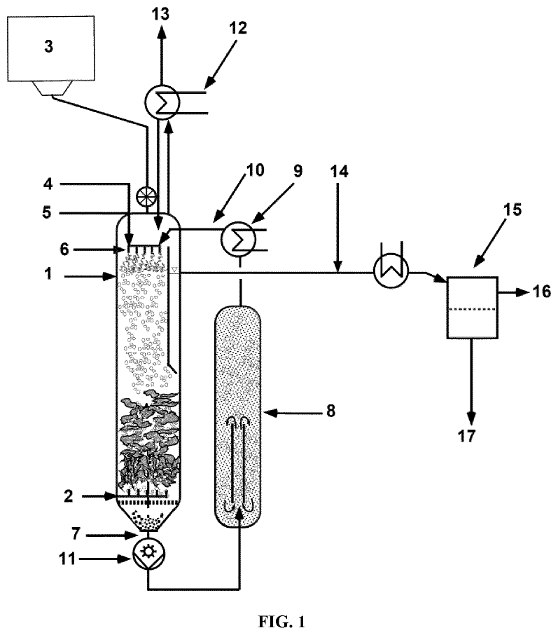

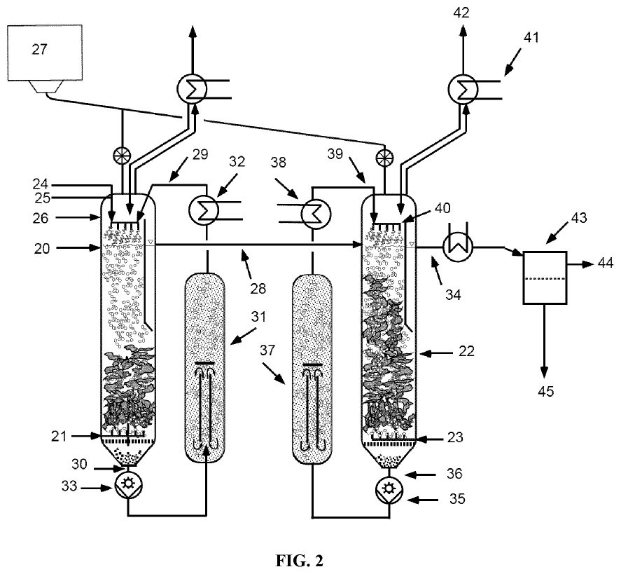

In the present disclosure, and as depicted in the accompanying drawings (FIGS. 1 and 2), nickel leaching to manufacture a nickel sulfate product is carried out in a primary vessel, such as a bubble column or a trickle-bed reactor. In a bubble column set-up, nickel metal is continuously fed into the primary vessel via a handling device and sulfuric acid and water are dosed into the primary vessel, either separately or as a solution, using a dispersion device to destroy potentially formed foam. In a trickle-bed reactor vessel set-up, nickel metal is packed into the vessel and sulfuric acid and water are introduced into the primary vessel and flow through the bed of nickel metal particles to allow for leaching of the particles to form a primary nickel sulfate solution. In some embodiments, the nickel metal particles are configured as one large bed in the primary vessel. In some embodiments, the nickel metal particles are configured as multiple beds in their own shells within the primary vessel. In some embodiments, the nickel metal particles are configured as several horizontal beds. In some embodiments, the nickel metal particles are configured as several parallel packed tubes.

The process is carried out in the absence of oxygen and under an inert atmosphere, under ambient pressure and at temperatures of between about 50° C. and about 120° C.

An off-gas flow, comprising mainly hydrogen and water vapor, is produced at the top of the primary vessel. The water vapor is condensed in a condenser and returned to the primary vessel and the hydrogen gas can flow through the condenser and may be collected. A primary nickel sulfate solution, produced in the primary vessel, is then fed into a secondary vessel where it further reacts with any unreacted nickel metal collected from the primary vessel and fresh nickel metal added to the secondary vessel. The secondary vessel can be a bubble column or a trickle-bed reactor.

In both the primary and secondary vessels, the nickel sulfate solution is continuously circulated from the bottom to the head of the vessels using one or more pumps. This operation helps maintain dispersion of the nickel particles in the nickel sulfate solutions and hinders the particles from settling.

The second step of the process results in a secondary nickel sulfate solution, which has a higher pH as well as a higher nickel concentration compared to the primary nickel sulfate solution and is filtered to obtain a desired nickel sulfate product of a targeted concentration and pH specification.

The secondary nickel sulfate solution is passed through a settler, which in the secondary vessel, holds back nickel particles. Finally, the secondary nickel sulfate solution is cooled to about 50° C. using, for example, a heat exchanger (such as an air cooler) and then passed through a filter, such as a cross flow filter, to remove fine particles which were not separated in the settler. The filtered solution is then passed into a storage tank and stored as the nickel sulfate product that has a desired nickel concentration and pH specification. The slurry from the filtration, which is concentrated with particles, is disposed of. The particles could also be dissolved using from about 18 wt % to about 96 wt % of sulfuric acid, such as from about 18 wt % to about 50 wt % sulfuric acid and the resulting solution could then be fed back into the primary vessel. Alternatively, the particles can be collected from the slurry and fed back into the primary vessel as solid particles.

As this process is slightly exothermic, heat has to be introduced into the process. The hydrogen from the off-gas flow that is produced as a side-product and collected, can be thermically used with a burner to heat a steam drum, which is charged with water used in the process. Steam, thus produced, can be fed into the primary and/or secondary vessels as a heat source to control the temperature.

The following description provides various embodiments of the different aspects of the disclosed processes and systems for dissolving elemental nickel in sulfuric acid solutions to provide nickel sulfate products, and for example, nickel sulfate products suitable for battery materials productions.

### Processes

The present disclosure provides for a process for preparing a nickel sulfate product wherein the process comprises the steps of (a) introducing elemental nickel, sulfuric acid, and water into a primary vessel to form a primary nickel sulfate solution; (b) transferring the primary nickel sulfate solution from the primary vessel to a secondary vessel and adding additional elemental nickel, wherein the secondary vessel collects unreacted nickel and allows the primary nickel sulfate solution to further react with any unreacted nickel to form a secondary nickel sulfate solution; (c) collecting a high purity hydrogen off-gas flow from the primary vessel and/or the secondary vessel; and (d) filtering the secondary nickel sulfate solution to collect the nickel sulfate product.

In some embodiments, the process is free of oxygen. In some embodiments, the process is free of air. In some embodiments, the process is free of hydrogen peroxide.

In some embodiments, the process of the present disclosure produces a high purity hydrogen off-gas. In some embodiments, the high purity hydrogen off-gas is in the range of about 50% to about 100% pure hydrogen. In some embodiments, the hydrogen off-gas is about 50% pure. In some embodiments, the hydrogen off-gas is about 60% pure. In some embodiments, the hydrogen off-gas is about 70% pure. In some embodiments, the hydrogen off-gas is about 80% pure. In some embodiments, the hydrogen off-gas is about 90% pure. In some embodiments, the hydrogen off-gas is about 95% pure. In some embodiments, the hydrogen off-gas is about 100% pure. In some embodiments, the purity of the hydrogen off-gas depends on the inert atmosphere used in the process. In some embodiments, the high purity hydrogen off-gas flow is carried to a burner and used to heat water to produce steam. In some embodiments, the burner is a porous burner. In some embodiments, the steam is used as a heat source in the process. In some embodiments, the produced steam is carried back to and fed into the bottom of the primary vessel and used as a heat source to heat the primary nickel sulfate solution. In some embodiments, the produced steam is carried back to and fed into the bottom of the secondary vessel and used as a heat source to heat the secondary nickel sulfate solution. In some embodiments, the produced steam is carried back to and fed into the bottom of the primary and secondary vessels and used as a heat source to heat the primary and secondary nickel sulfate solutions.

In some embodiments, the process is carried out at a temperature ranging from about 40° C. to about 200° C. In some embodiments, the process is carried out at a temperature ranging from about 50° C. to about 180° C. In some embodiments, the process is carried out at a temperature ranging from about 60° C. to about 160° C. In some embodiments, the process is carried out at a temperature ranging from about 70° C. to about 140° C. In some embodiments, the process is carried out at a temperature ranging from about 80° C. to about 120° C. In some embodiments, the process is carried out at a temperature of about 80° C. In some embodiments, the process is carried out at a temperature of about 90° C. In some embodiments, the process is carried out at a temperature of about 100° C. In some embodiments, the process is carried out at a temperature of about 110° C. In some embodiments, the process is carried out at a temperature of about 120° C. In some embodiments, the primary vessel and the secondary vessel are at the same temperature or at different temperatures within the range from about 40° C. to about 200° C.

In some embodiments, the elemental nickel particles are of irregular shapes and sizes. In some embodiments the elemental nickel particles have uniform shapes and sizes. In some embodiments, the elemental nickel particles are in the form of lumps. In some embodiments, the elemental nickel particles are in the form of turnings. In some embodiments, the elemental nickel particles are in the form of pellets. In some embodiments, the elemental nickel particles are in the form of rounds. In some embodiments, the elemental nickel particles are in the form of cathodes. In some embodiments, the elemental nickel particles are in the form of electrode fragments. In some embodiments, the elemental nickel particles are in the form of briquettes. In some embodiments, the elemental nickel particles are in the form of powder. In some embodiments, the elemental nickel particles are in the form of a combination of one or more of pellets, rounds, cathodes, briquettes, and powders. In some embodiments, the briquettes are made up of powder and/or fragments that are combined with a binder to form briquettes. In some embodiments, the nickel particles are introduced in a liquid form. In some embodiments the nickel particles are introduced as a liquid containing nickel particles. In some embodiments, the nickel particles are introduced as a liquid containing nickel/nickel oxide (Ni/NiO) particles.

In some embodiments, the elemental nickel powders have an average particle diameter in the range from about 0.01 mm to about 1 mm. In some embodiments, the elemental nickel powders have an average particle diameter in the range from about 0.01 mm to about 0.15 mm. In some embodiments, the nickel lumps have a length, width and height in the range from about 5 mm to about 10 cm. In some embodiments, the nickel turnings have a thickness in the range from about 0.1 mm to about 1 mm, a width in the range from about 1 mm to about 5 mm and a length in the range from about 1 cm to about 20 cm. In some embodiments, the nickel briquettes have a length in the range from about 2 cm to about 4 cm and a diameter in the range from about 12 mm to about 14 mm. In some embodiments, the nickel electrode fragments have a thickness in the range from about 0.5 mm to about 7 mm. In some embodiments, the nickel electrode fragments have a thickness in the range from about 1 mm to about 10 mm. In some embodiments, uncut nickel electrode fragments have a thickness in the range from about 1 mm to about 3 mm and irregular cross sections, with the diameter at the broadest place not exceeding about 40 mm and the average diameter being in the range from about 10 mm to about 30 mm. In some embodiments, cut nickel electrodes can have a thickness in the range from about 0.5 mm to about 7 mm. In some embodiments, the size of the nickel electrodes are about 10 cm×about 10 cm×about 10 cm.

In some embodiments, the elemental nickel is continuously fed into the primary vessel. In some embodiments, the elemental nickel is continuously fed into the secondary vessel. In some embodiments, the elemental nickel is continuously fed into the primary and secondary vessels.

In some embodiments, the elemental nickel is added to the primary and/or secondary reaction vessel in the form of a powder. For example, coarse nickel material can be transformed to Ni powder by, e.g., a thermal spraying (i.e., gas atomization process), a water atomization process (high pressure), a carbonyl refining process, a hydrometallurgical process (i.e., hydrogen reduction process). (P. Samal, J. Newkirk, ASM Handbook, Volume 7, Powder Metallurgy, 2015.). Accordingly, in some embodiments, powder nickel material can be dosed into the primary and/or the secondary vessel by direct spraying.

In some embodiments, the sulfuric acid used to carry out the process is a sulfuric acid comprising water which can be protonated or unprotonated. In some embodiments, the water content of the sulfuric acid can be in a range from about 5% to about 95% by weight, based on H₂SO₄. In some embodiments, the water content of the sulfuric acid can be in a range from about 15% to about 30% by weight, based on H₂SO₄. In some embodiments, the concentration of the sulfuric acid chosen is dependent on the concentration of the nickel sulfate product being targeted.

In some embodiments, the nickel is placed in the primary vessel and water and sulfuric acid are then added to form an acidic primary nickel sulfate solution. In some embodiments, the acidic primary nickel sulfate solution formed is removed continuously and fresh nickel, water and/or sulfuric acid is added. In some embodiments, the sulfuric acid is pre-mixed with the water and then added as a diluted sulfuric acid. In some embodiments, sulfuric acid from the primary vessel can be recycled. In some embodiments, the recycled sulfuric acid contains nickel ions from the nickel particles.

In some embodiments, the process is carried out continuously, with the nickel sulfate solutions and/or product being removed and elemental nickel, water and sulfuric acid being replenished, as necessary. In some embodiments, the process of the present disclosure is carried out batchwise.

In some embodiments, the primary vessel comprises one or more circulation devices for circulating the primary nickel sulfate solution. In some embodiments, the secondary vessel comprises one or more circulation devices for circulating the secondary nickel sulfate solution. In some embodiments, the primary and secondary vessels comprise one or more circulation devices for circulating the primary and secondary nickel sulfate solutions.

In some embodiments, the circulation device comprises a separator and/or one or more pumps. In some embodiments, the separator is a loop separator. In some embodiments, the separator is cyclone separator. In some embodiments, the circulation device is a pump. In some embodiments, the circulation device is two or more pumps. In some embodiments, the circulation device is a combination of a cyclone separator and one or more pumps. In some embodiments, the circulation device is a combination of a loop separator and one or more pumps. Those of ordinary skill in the art will recognize or be able to ascertain using no more than routine experimentation, many equivalents to the circulation device described herein. Such equivalents are intended to be encompassed herein.

In some embodiments, foam formation in the primary vessel is minimized using a dispersion device. In some embodiments, foam formation in the secondary vessel is minimized using a dispersion device. In some embodiments, the dispersion device is a sprinkler. In some embodiments the water and sulfuric acid are introduced into the primary vessel using a sprinkler. In some embodiments the primary nickel sulfate solution is introduced into the secondary vessel using a sprinkler. In some embodiments, the dispersion device is a steamer. In some embodiments, the dispersion device is a centrifuge. In some embodiments, the dispersion device is chosen from one or more of a sprinkler, steamer, and centrifuge. Those of ordinary skill in the art will recognize or be able to ascertain using no more than routine experimentation, many equivalents to the dispersion device described herein. Such equivalents are intended to be encompassed herein.

In some embodiments, the process is carried out at ambient pressure. In some embodiments, the process is carried out at a pressure above ambient pressure. In some embodiments, the process is carried out under an inert atmosphere. In some embodiments, the inert atmosphere is hydrogen. In some embodiments, the inert atmosphere is water vapor. In some embodiments, the inert atmosphere is nitrogen. In some embodiments, the inert atmosphere is argon. In some embodiments, the inert atmosphere is a combination of two or more gases chosen from hydrogen, water vapor, nitrogen and argon.

In some embodiments, the primary nickel sulfate solution has an Ni2 concentration ranging between about 70 g/l and about 200 g/l. In some embodiments, the primary nickel sulfate solution has an Ni²⁺ concentration ranging between about 90 g/l and about 150 g/l. In some embodiments, the primary nickel sulfate solution has an Ni²⁺ concentration ranging between about 100 g/l and about 140 g/l. In some embodiments, the primary nickel sulfate solution has an Ni²⁺ concentration of about 110 g/l. In some embodiments, the primary nickel sulfate solution has an Ni²⁺ concentration of about 118 g/l. In some embodiments, the primary nickel sulfate solution has an Ni²⁺ concentration of about 120 g/l. In some embodiments, the primary nickel sulfate solution has an Ni²⁺ concentration of about 130 g/l. In some embodiments, the primary nickel sulfate solution has an Ni²⁺ concentration of about 140 g/l. In some embodiments, the primary nickel sulfate solution has an Ni²⁺ concentration of about 120 g/l.

In some embodiments, the primary nickel sulfate solution in the primary vessel has a pH ranging from about 0 to about 2. In some embodiments, the primary nickel sulphate has a pH below about 0. In some embodiments, the primary nickel sulfate solution has a pH ranging from about 0 to about 1.5. In some embodiments, the primary nickel sulfate solution has a pH of about 1.2. In some embodiments, the primary nickel sulfate solution has a pH of about 1.4. In some embodiments, the primary nickel sulfate solution has a pH of about 1.6. In some embodiments, the primary nickel sulfate solution has a pH of about 1.8. In some embodiments, the pH depends on the concentration of the dosed sulfuric acid. In some embodiments, the pH is measured using a glass electrode. In some embodiments, the pH is measured using a combination electrode.

In some embodiments, the secondary nickel sulfate solution has an Ni²⁺ concentration ranging between about 70 g/l and about 200 g/l. In some embodiments, the secondary nickel sulfate solution has an Ni2 concentration ranging between about 90 g/l and about 150 g/l. In some embodiments, the secondary nickel sulfate solution has an Ni²⁺ concentration ranging between about 100 g/l and about 140 g/l. In some embodiments, the secondary nickel sulfate solution has an Ni²⁺ concentration of about 110 g/l. In some embodiments, the secondary nickel sulfate solution has an Ni²⁺ concentration of about 118 g/l. In some embodiments, the secondary nickel sulfate solution has an Ni²⁺ concentration of about 120 g/l. In some embodiments, the secondary nickel sulfate solution has an Ni2 concentration of about 130 g/l. In some embodiments, the secondary nickel sulfate solution has an Ni²⁺ concentration of about 140 g/l. In some embodiments, the secondary nickel sulfate solution has an Ni²⁺ concentration of about 150 g/l. In some embodiments, the Ni²⁺ concentration of the of the secondary nickel sulfate solution is higher than the Ni²⁺ concentration of the primary nickel sulfate solution.

In some embodiments, the nickel sulfate product has an Ni²⁺ concentration ranging between about 70 g/l and about 200 g/l. In some embodiments, the nickel sulfate product has an Ni²⁺ concentration ranging between about 90 g/l and about 150 g/l. In some embodiments, the nickel sulfate product has an Ni²⁺ concentration ranging between about 100 g/l and about 140 g/l. In some embodiments, the nickel sulfate product has an Ni²⁺ concentration of about 110 g/l. In some embodiments, the nickel sulfate product has an Ni²⁺ concentration of about 118 g/l. In some embodiments, the nickel sulfate product has an Ni²⁺ concentration of about 120 g/l. In some embodiments, the nickel sulfate product has an Ni²⁺ concentration of about 130 g/l. In some embodiments, the nickel sulfate product has an Ni²⁺ concentration of about 140 g/l. In some embodiments, the nickel sulfate product has an Ni²⁺ concentration of about 150 g/l.

In some embodiments, the nickel sulfate product has pH ranging from about 2 to about 4. In some embodiments, the nickel sulfate product has pH ranging from about 2.2 to about 3.8. In some embodiments, the nickel sulfate product has pH ranging from about 2.4 to about 3.6. In some embodiments, the nickel sulfate product has pH ranging from about 2.5 to about 3.5. In some embodiments, the nickel sulfate product has pH of about 2.5. In some embodiments, the nickel sulfate product has pH of about 2.6. In some embodiments, the nickel sulfate product has pH of about 2.7. In some embodiments, the nickel sulfate product has pH of about 2.8. In some embodiments, the nickel sulfate product has pH of about 2.9. In some embodiments, the nickel sulfate product has pH of about 3.0.

In some embodiments, the nickel sulfate product of the present disclosure is suitable for use without further purification. For example, the process comprises (a) introducing elemental nickel, sulfuric acid, and water into a primary vessel to form a primary nickel sulfate solution; (b) transferring the primary nickel sulfate solution from the primary vessel to a secondary vessel and adding additional elemental nickel, wherein the secondary vessel collects unreacted nickel and allows the primary nickel sulfate solution to further react with any unreacted nickel to form a secondary nickel sulfate solution; (d) collecting a high purity hydrogen off-gas flow from the primary vessel and/or the secondary vessel; and (d) filtering the secondary nickel sulfate solution to collect the nickel sulfate product. In some embodiments, the nickel sulfate product is filtered over active carbon to remove organic compounds. In some embodiments, the organic compounds are binders from the nickel briquettes. After the filtering of the secondary nickel sulfate solution to collect the nickel sulfate product, a further purification is not needed. The purification or the degree of purified nickel sulfate product is dependent on several factors. For example, the purity of the starting materials, i.e., the elemental nickel, sulfuric acid, and water and the continued influx of one or more of these materials into the process. The purity of the nickel sulfate product ranges from about 50% to about 100%. In some embodiments, the purity of the nickel sulfate product ranges from about 95% to about 100%. In some embodiments, the purity of the nickel sulfate product ranges from about 98% to about 100%.

### Systems

The present disclosure also provides for a system for preparing a nickel sulfate product, wherein the system comprises: (i) a primary vessel with a settler for mixing elemental nickel, sulfuric acid, and water to form a primary nickel sulfate solution; (ii) a secondary vessel with a settler to collect unreacted nickel particles and the primary nickel sulfate solution for further mixing with additional elemental nickel to form a secondary nickel sulfate solution; (iii) an off-gas flow line for collecting high purity hydrogen off-gas from the primary vessel and/or the secondary vessel; and (iv) a filter for filtering the secondary nickel sulfate solution to collect the nickel sulfate product.

In some embodiments, the system comprises (i) a primary vessel with a settler for mixing elemental nickel, sulfuric acid, and water to form a primary nickel sulfate solution; and (ii) a secondary vessel with a settler to collect unreacted nickel particles and the primary nickel sulfate solution for further mixing with additional elemental nickel to form a secondary nickel sulfate solution. In some embodiments, the vessels are made of epoxy resins, unfilled or filled with glass fibers. In some embodiments, the vessels are laminated epoxy-glass fiber materials. In some embodiments, the vessels are plastics such as polypropylene, PVC or PVDF. In some embodiments, the vessels comprise plastic tubing introduced into steel outers. In some embodiments, the vessels are made of lead or lead alloys. In some embodiments, the vessels are metal vessels such as steel. In some embodiments, the steel vessels are lined with the abovementioned material.

In some embodiments, the system comprises: (iii) an off-gas flow line for collecting high purity hydrogen off-gas from the primary vessel and/or the secondary vessel. In some embodiments, the off-gas flow line further connects from a head of the primary vessel to a burner, to heat water for the production of steam. In some embodiments, the off-gas flow line further connects from a head of the secondary vessel to a burner, to heat water for the production of steam. In some embodiments, the off-gas flow line further connects from the head of the primary and secondary vessels to a burner, to heat water for the production of steam. In some embodiments, the burner is a porous burner.

In some embodiments, the system further comprises: (iv) a filter for filtering the secondary nickel sulfate solution to collect the nickel sulfate product. In some embodiments, the filter is a membrane filter.

In some embodiments, the system further comprises a tube to carry the produced steam into the bottom of the primary vessel to control the temperature therein. In some embodiments, the system further comprises a tube to carry the produced steam into the bottom of the secondary vessel to control the temperature therein. In some embodiments, the system further comprises a tube to carry the produced steam into the bottom of the primary and secondary vessels to control the temperatures therein.

Claims or descriptions that include “or” or “and/or” between at least two members of a group are considered satisfied if one, more than one, or all of the group members are present in, employed in, or otherwise relevant to a given product, process, or system unless indicated to the contrary or otherwise evident from the context. The disclosure includes embodiments in which exactly one member of the group is present in, employed in, or otherwise relevant to a given product, process, or system. The disclosure includes embodiments in which more than one, or all the group members are present in, employed in, or otherwise relevant to a given product, process, or system.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the claims.

Before describing exemplary embodiments of the present disclosure, it is to be understood that the disclosure is not limited to the details of construction or process steps set forth in the following examples and is capable of other embodiments and of being practiced or being carried out in various ways.

### EXAMPLES

The following examples are intended to be illustrative and are not meant in any way to limit the scope of the disclosure.

### Experimental Step-Up for a One Column Process:

As shown in FIG. 1, a bubble column vessel (1) is provided with a gas inlet tube (2) for supplying nitrogen gas from a nitrogen gas supply and a handling device (3) for supplying nickel metal particles. The nitrogen gas is used to create an inert atmosphere in the vessel (1) and to mix a reaction mixture therein using nitrogen gas bubbles. The vessel (1) also contains two inlet tubes (4 and 5) at the top of the vessel (1) for introducing sulfuric acid and water, respectively. The sulfuric acid and water are introduced into the vessel (1) via a dispersion device (6), to minimize foam formation.

A liquid containing Ni/NiO particles is continuously pumped with a pump (11) from the bottom to the top of the vessel (1) via an outlet (7) at the bottom of the vessel (1), through a separator (8) and a heat exchanger (9) and back into the vessel (1) through an inlet (10). When the liquid is passed back into the top of the vessel (1), it may also introduced via the dispersion device (6). A sampling point (not shown) is installed between the vessel outlet (7) and the separator (8), to allow for sampling of the reaction mixture during production. An off-gas containing hydrogen and water vapor is produced in the process and passed through a condenser (12) above the vessel (1). The water vapor condenses and is fed back into the vessel (1) during use and the hydrogen gas (13) passes through the condenser (12) and can be collected for further use. The pH of the reaction mixture, the amount of dosed sulfuric acid and water and the nickel weight and concentration of the collected nickel sulfate product can be continuously monitored during the process. The nickel sulfate product is transferred from the vessel (1) via an outlet (14) and through a filter (15) to separate the nickel sulfate product (17) from solid waste (16).

### Procedure for a One-Column Set-Up:

Six kg of elemental nickel, in the form of briquettes, were fed into a vessel and 3.2 L of 18 wt % aqueous sulfuric acid were added to the vessel. 20 nL/h nitrogen gas was bubbled through the reaction mixture. In this way, the nickel sulfate solution was continuously circulated. The nickel sulfate solution was heated to 80° C. (internal temperature) and the spent nickel amount was compensated by continuous addition of nickel briquettes. As soon as the nickel sulfate solution reached a target nickel concentration of 126 g/L, 18 wt % aqueous sulfuric acid was dosed at a rate of 500 nL/h for 5.3 h. After equilibration, a pH of 1.4 was reached and 3419 g of a 126 g/L nickel sulfate solution was obtained. The reaction rate of nickel dissolution was determined to be 60 g/h. Within the considered operation time of 5.3 h, nickel briquettes were not continuously fed into the vessel.

### Prophetic Experimental Step-Up for a Two-Column Process:

As shown in FIG. 2, a primary vessel (20) bubble column is equipped with a gas inlet tube (21) at the bottom of the primary vessel (20) for supplying nitrogen gas. Similarly, a secondary vessel (22) bubble column is equipped with a gas inlet tube (23) at its bottom for supplying nitrogen gas. The nitrogen gas supplies are used for creating an inert atmosphere in the vessels and for mixing nickel sulfate solutions therein using nitrogen gas bubbles.

The primary vessel (20) contains two inlet tubes (24 and 25) at the top for introducing sulfuric acid and water, respectively, above the liquid level in the primary vessel (20) and a handling device (27) for supplying nickel metal particles. The sulfuric acid and water are introduced into the primary vessel (20) via an inlet tubes 24 and 25. They may also be introduced via a dispersion device (26), to minimize foam formation. The primary vessel (20) has a primary overflow drain (28) to keep the liquid level therein constant. The overflow is collected in the secondary vessel (22).

An inlet (29) is provided on top of the primary vessel (20) for introducing a liquid containing Ni/NiO particles into the primary vessel (20). This liquid is continuously pumped by a pump (33) from the bottom of the primary vessel (20), via an outlet (30) through a separator (31) and a heat exchanger (32) to the top of the primary vessel (20). A sampling point (not shown is installed between the primary vessel (20) and the separator (31) to allow for sampling of the primary nickel sulfate solution during the process.

The primary vessel (20) is connected to the secondary vessel (22) by its primary overflow drain (28), and the secondary vessel (22) has an outlet (34) to remove the secondary nickel sulfate solution produced therein. This secondary nickel sulfate solution in the secondary vessel (22) is continuously circulated by passing through a pump (35) from the bottom of the secondary vessel (22), via an outlet (36) through a separator (37) and a heat exchanger (38) to the top of the secondary vessel (22). A sampling point (not shown) is installed at the bottom of the secondary vessel (22), between the outlet (36) and the separator (37), for sampling the secondary nickel sulfate solution during production. The secondary nickel sulfate solution is transferred into the secondary vessel (22) through inlet (39), via a secondary dispersion device (40) to minimize foam formation. Additional nickel metal can be introduced into the secondary vessel (22) from the handing device (27).

An off-gas containing hydrogen and water vapor, produced during the process passes from the secondary vessel (22) through a condenser (41). The condensed water vapor is fed back into the secondary vessel (22) and the hydrogen gas (42) is released and can be collected for further use. For example, the hydrogen gas (42) can be carried to a burner and used to heat water to produce steam. The produced steam can be fed into the bottom of the primary and secondary vessels as a heat source to control the temperature in the primary and secondary vessels during use.

Finally, the outlet (34) of the secondary vessel (22) is connected to a filter (43) which is used to separate out the solid components (44) from the final nickel sulfate product (45).

### Prophetic Procedure for a Two-Column Set-Up:

Elemental nickel particles are fed into a primary vessel and sulfuric acid and water are added to the primary vessel. Nitrogen gas is bubbled through the primary nickel sulfate solution produced in the primary vessel and the primary nickel sulfate solution is continuously circulated while being heated to between about 40° C. and about 200° C. (internal temperature). The spent elemental nickel in the primary vessel is compensated by continuous addition of nickel particles. The nickel concentration of the primary nickel solution is determined by measuring samples taken between the primary vessel and the separator, and sulfuric acid is added at a required rate for a specified period, if necessary. After equilibration and when the primary nickel sulfate solution reaches a desired pH between about 0.5 to about 2.0 and a desired concentration between about 90 g/l and about 200 g/l is reached, the primary nickel sulfate solution is passed to a secondary vessel through a primary vessel overflow drain to form a secondary nickel sulfate solution.

Nitrogen gas is bubbled through the secondary nickel sulfate solution in the secondary vessel and the secondary nickel sulfate solution is, in this way, continuously circulated. The secondary nickel sulfate solution is also heated to a desired temperature between about 40° C. and about 200° C. (internal temperature). The spent nickel metal amount in the secondary vessel is compensated by continuous addition of nickel metal. During the process, the secondary nickel sulfate solution is constantly measured to determine pH, reaction rate, and concentration.

During this process, an off-gas containing water vapor and hydrogen is produced. The water vapor condenses in a condenser above the vessels and the condensate is carried back to the vessels. The hydrogen off-gas can be carried to a burner where it can be used to heat water for the production of steam. The produced steam can then be carried back to the vessels and fed into the bottom of the primary and secondary vessels where it can be used as a heat source to control the temperature in the primary and secondary vessels during use. The primary and secondary vessels can also be heated using a heat exchanger.

When the secondary nickel sulfate solution has reached equilibration, a desired pH of between about 2.0 and about 4.0, and a desired concentration, the secondary nickel sulfate solution is transferred to a separation system to separate out the solid components and obtain a final nickel sulfate product which is ready for use without requiring any additional work-up or purification steps.

### Embodiments

1. A process for preparing a nickel sulfate product, the process comprising:
introducing elemental nickel, sulfuric acid, and water into a primary vessel to form a primary nickel sulfate solution;
transferring the primary nickel sulfate solution from the primary vessel to a secondary vessel and adding additional elemental nickel, wherein the secondary vessel collects unreacted nickel and allows the primary nickel sulfate solution to further react with any unreacted nickel to form a secondary nickel sulfate solution;
collecting a high purity hydrogen off-gas flow from the primary vessel and/or the secondary vessel; and
filtering the secondary nickel sulfate solution to collect the nickel sulfate product.
   2. The process according to embodiment 1, wherein the process is free of oxygen.
   3. The process according to embodiment 1 or 2, wherein the process is free of air.
   4. The process according to any one of embodiments 1-3, wherein the process is free of hydrogen peroxide.
   5. The process according to any one of embodiments 1-4, wherein the high purity hydrogen off-gas flow heats water to produce steam.
   6. The process according to embodiment 5, wherein the steam is used for controlling the temperature of the process in the primary vessel.
   7. The process according to embodiment 5 or 6, wherein the steam is used for controlling the temperature of the process in the secondary vessel.
   8. The process according to any one of embodiments 1-7, wherein the process is carried out at a temperature ranging from about 40° C. to about 200° C.
   9. The process according to any one of embodiments 1-8, wherein the process is carried out at a temperature ranging from about 60° C. to about 150° C.
   10. The process according to any one of embodiments 1-9, wherein the process is carried out at a temperature ranging from about 80° C. to about 100° C.
   11. The process according to any one of embodiments 1-10, wherein the process is carried out at a temperature of about 80° C.
   12. The process according to any one of embodiments 1-11, wherein the elemental nickel particles of irregular shapes and sizes.
   13. The process according to any one of embodiments 1-12, wherein the elemental nickel is in a form chosen from pellets, rounds, cathodes, briquettes, powder, and combinations thereof.
   14. The process according to any one of embodiments 1-13, wherein the elemental nickel is continuously fed into the primary vessel.
   15. The process according to any one of embodiments 1-14, wherein the elemental nickel is continuously fed into the secondary vessel.
   16. The process according to any one of embodiments 1-15, wherein the primary vessel comprises one or more circulation devices for circulating the primary nickel sulfate solution.
   17. The process according to any one of embodiments 1-16, wherein the secondary vessel comprises one or more circulation devices for circulating the secondary nickel sulfate solution.
   18. The process according to embodiment 16 or 17, wherein the circulation device is chosen from a particle separator, one or more pumps, and combinations thereof.
   19. The process according to any one of embodiments 1-18, wherein the primary vessel comprises a dispersion device to minimize foam formation.
   20. The process according to any one of embodiments 1-18, wherein the secondary vessel comprises a dispersion device to minimize foam formation.
   21. The process according to embodiment 19 or 20, wherein the dispersion device is chosen from sprinklers, steamers, centrifuges, and combinations thereof.
   22. The process according to any one of embodiments 1-21, wherein the process is carried out at ambient pressure.
   23. The process according to any one of embodiments 1-21, wherein the process is carried out at a pressure above ambient pressure.
   24. The process according to any one of embodiments 1-23, wherein the process is carried out under an inert atmosphere.
   25. The process according to embodiment 24, wherein the inert atmosphere is chosen from hydrogen, water vapor, nitrogen, argon, and combinations thereof.
   26. The process according to any one of embodiments 1-25, wherein the primary nickel sulfate solution has an Ni²⁺ concentration ranging from about 70 g/l to about 200 g/l.
   27. The process according to any one of embodiments 1-26, wherein the primary nickel sulfate solution has a concentration ranging from about 90 g/l to about 150 g/l.
   28. The process according to any one of embodiments 1-27, wherein the primary nickel sulfate solution has an Ni²⁺ concentration ranging from about 110 g/l to about 140 g/l.
   29. The process according to any one of embodiments 1-28, wherein the primary nickel sulfate solution has an Ni²⁺ concentration of about 120 g/l.
   30. The process according to any one of embodiments 1-29, wherein the primary nickel sulfate solution in the primary vessel has a pH ranging from about 0 to about 2.
   31. The process according to any one of embodiments 1-30, wherein the primary nickel sulfate solution in the primary vessel has a pH ranging from about 1.0 to about 2.
   32. The process according to any one of embodiments 1-31, wherein the primary nickel sulfate solution in the primary vessel has a pH of about 1.4.
   33. The process according to any one of embodiments 1-29, wherein the primary nickel sulfate solution in the primary vessel has a pH less than about 0.
   34. The process according to any one of embodiments 1-33, wherein the pH of the primary nickel sulfate solution in the primary vessel is controlled by the concentration of sulfuric acid added to the primary nickel sulfate solution.
   35. The process according to any one of embodiments 1-34, wherein the nickel sulfate product has pH ranging from about 2 to about 4.
   36. The process according to any one of embodiments 1-35, wherein the nickel sulfate product has pH ranging from about 2.2 to about 3.8.
   37. The process according to any one of embodiments 1-36, wherein the nickel sulfate product has pH ranging from about 2.4 to about 3.6.
   38. The process according to any one of embodiments 1-37, wherein the nickel sulfate product has pH ranging from about 2.5 to about 3.5.
   39. The process according to any one of embodiments 1-38, wherein the nickel sulfate product has pH of about 3.0.
   40. The process according to any one of embodiments 1-39, wherein the pH of the nickel sulfate product can be further adjusted by adding one or more metal hydroxides.
   41. The process according to embodiment 40, wherein the metal hydroxides are chosen from NaOH, KOH, Ni (OH)₂, and combinations thereof.
   42. The process according to any one of embodiments 1-41, wherein the nickel sulfate product is suitable for use without further purification.
   43. The process according to any one of embodiments 1-42, wherein the nickel sulfate product is filtered over active carbon.
   44. A system for preparing a nickel sulfate product, the system comprising:
a primary vessel with a settler for mixing elemental nickel, sulfuric acid, and water to form a primary nickel sulfate solution;
a secondary vessel with a settler to collect unreacted nickel particles and the primary nickel sulfate solution for further mixing with additional elemental nickel to form a secondary nickel sulfate solution;
an off-gas flow line for collecting high purity hydrogen off-gas from the primary vessel and/or the secondary vessel; and
a filter for filtering the secondary nickel sulfate solution to produce the nickel sulfate product.
   45. The system according to embodiment 44, wherein the off-gas line further connects from a head of the primary vessel to a porous burner, to heat water for producing steam.
   46. The system according to embodiment 44, wherein the off-gas line further connects from a head of the secondary vessel to a porous burner, to heat water for producing steam.
   47. The system according to embodiment 45, further comprising a tube to carry the produced steam into the bottom of the primary vessel to control the temperature therein.
   48. The system according to embodiment 46, further comprising a tube to carry the produced steam into the bottom of the secondary vessel to control the temperature therein.
   49. The system according to any one of embodiments 44-48, wherein the primary vessel further comprises one or more circulation devices for circulating the primary nickel sulfate solution.
   50. The system according to any one of embodiments 44-49, wherein the secondary vessel further comprises one or more circulation devices for circulating the secondary nickel sulfate solution.
   51. The system according to embodiment 49 or 50 wherein the one or more circulation devices are chosen from a particle separator, one or more pumps, and combinations thereof.
   52. The system according to any one of embodiments 44-51, wherein the primary vessel further comprises a dispersion device for minimizing foam formation therein.
   53. The system according to any one of embodiments 44-52, wherein the secondary vessel further comprises a dispersion device for minimizing foam formation therein.
   54. The system according to embodiment 52 or 53, wherein the dispersion device is chosen from sprinklers, steamers, centrifuges, and combinations thereof.
   55. The process according to any one of embodiments 1-42, wherein the elemental nickel is added to the primary and/or secondary reaction vessel in the form of a nickel powder and the nickel powder is produced by a process chosen from thermal spraying, water atomization, carbonyl refining, and hydrometallurgy.
   56. The process according to embodiment 55, wherein the step of introducing elemental nickel is done by direct spraying into the primary and/or secondary vessel.

1. A process for preparing a nickel sulfate product, the process comprising:
introducing elemental nickel, sulfuric acid, and water into a primary vessel to form a primary nickel sulfate solution;
transferring the primary nickel sulfate solution from the primary vessel to a secondary vessel and adding additional elemental nickel, wherein the secondary vessel collects unreacted nickel and allows the primary nickel sulfate solution to further react with any unreacted nickel to form a secondary nickel sulfate solution;
collecting a high purity hydrogen off-gas flow from the primary vessel and/or the secondary vessel; and
filtering the secondary nickel sulfate solution to collect the nickel sulfate product.

2. The process according to claim 1, wherein the high purity hydrogen off-gas flow is used to heat water to produce steam for controlling the temperature of the process in the primary vessel and/or the secondary vessel.

3. The process according to claim 1, wherein the process is free of oxygen, air, and hydrogen peroxide.

4. The process according to claim 1, wherein the process is carried out at a temperature ranging from about 40° C. to about 200° C.

5. The process according to claim 1, wherein the elemental nickel is in a form chosen selected from pellets, rounds, cathodes, briquettes, powder, and combinations thereof.

6. The process according to claim 1, wherein the primary nickel sulfate solution and the secondary nickel sulfate solution are continuously circulated in each vessel.

7. The process according to claim 1, wherein the primary and/or secondary vessels comprise a dispersion device to minimize foam formation.

8. The process according to claim 7, wherein the dispersion device is selected from sprinklers, steamers, centrifuges, and combinations thereof.

9. The process according to claim 1, wherein the process is carried out at a pressure above ambient pressure and under an inert atmosphere.

10. The process according to claim 9, wherein the inert atmosphere is selected from hydrogen, water vapor, nitrogen, argon, and combinations thereof.

11. The process according to claim 1, wherein the primary nickel sulfate solution has an Ni2+ concentration ranging from about 70 g/l to about 200 g/l and a pH ranging from about 0 to about 2.

12. The process according to claim 1, wherein the nickel sulfate product has pH ranging from about 2 to about 4.

13. The process according to claim 1, wherein the pH of the nickel sulfate product can be further adjusted by adding one or more metal hydroxides selected from NaOH, KOH, Ni(OH)₂, and combinations thereof.

14. The process according to claim 1, wherein the nickel sulfate product is suitable for use without further purification.

15. A system for preparing a nickel sulfate product, the system comprising:
a primary vessel with a settler for mixing elemental nickel, sulfuric acid, and water to form a primary nickel sulfate solution;
a secondary vessel with a settler to collect unreacted nickel particles and the primary nickel sulfate solution for further mixing with additional elemental nickel to form a secondary nickel sulfate solution;
an off-gas flow line for collecting high purity hydrogen off-gas from the primary vessel and/or the secondary vessel; and
a filter for filtering the secondary nickel sulfate solution to collect the nickel sulfate product.

16. The system according to claim 15, wherein the off-gas line further connects from a head of the primary vessel and/or a head of the secondary vessel to a burner, to heat water for producing steam.

17. The system according to claim 15, further comprising a tube to carry the produced steam into the bottom of the primary vessel and/or the bottom of the secondary vessel to control the temperature in the primary vessel and/or the secondary vessel.

18. The system according to claim 15, wherein the primary vessel and/or the secondary vessel further comprise one or more circulation devices for circulating the primary and/or secondary nickel sulfate solution.

19. The system according to claim 18, wherein the one or more circulation devices are selected from a separator, one or more pumps, and combinations thereof.

20. The system according to claim 15, wherein the primary and/or secondary vessels further comprise a dispersion device for minimizing foam formation therein.

21. The system according to claim 20, wherein the dispersion device is selected from sprinklers, steamers, centrifuges, and combinations thereof.
